(19) United States
(12) Patent Application Publication
(10) Pub. No.: US 2008/0118810 A1
(43) Pub. Date: May 22, 2008

(54) FUEL RECYCLING DEVICE AND FUEL CELL SYSTEM HAVING THE SAME

(75) Inventors: Won Hyouk Jang, Suwon-si (KR); Dae Ho Ko, Suwon-si (KR); Do Young Kim, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: SAMSUNG SDI CO., LTD., Suwon-si (KR)

(21) Appl. No.: 11/939,130

(22) Filed: Nov. 13, 2007

(30) Foreign Application Priority Data
Nov. 20, 2006 (KR) 10-2006-0114583

(51) Int. Cl. H01M 8/18

(52) U.S. Cl. 429/34

(57) ABSTRACT

A fuel recycling device comprises: a mixing tank, the mixing tank comprising: a fuel supplying port configured to supply into the mixing tank a concentrated fuel; a cathode inlet configured to supply into the mixing tank a cathode effluent of an external fuel cell stack; an anode inlet configured to supply into the mixing tank an anode effluent of the fuel cell stack; a stack supplying port configured to supply a mixed fuel comprising the concentrated fuel, the cathode effluent, and the anode effluent to the fuel cell stack; and a gas outlet configured to discharge gas therein; and a condenser coupled with the gas outlet, configured to condense the gas discharged from the mixing tank into a liquid.

### CROSS-REFERENCE TO RELATED APPLICATIONS

This application claims the benefit of Korean Patent Application No. 2006-0114583, filed on Nov. 20, 2006, in the Korean Intellectual Property Office, the disclosure of which is incorporated herein by reference.

### BACKGROUND OF THE INVENTION

1. Field of the Invention

The present invention relates to a fuel cell system having a fuel cell stack, and more particularly, to a fuel recycling device capable of effectively condensing fuel cell stack effluent and a fuel cell system having the same.

2. Description of the Related Art

In general, a fuel cell is a power generation system that directly converts chemical energy into electric energy by the electro-chemical reaction of hydrogen and oxygen. As for the hydrogen, pure hydrogen can directly be supplied to a fuel cell system or hydrogen obtained by reforming substances such as methanol, ethanol, and natural gas, etc. may be supplied thereto. As for the oxygen, pure oxygen may directly be supplied to a fuel cell system, and oxygen by the external air may be supplied thereto by using an air pump.

The fuel cell may be sorted into a polymer electrolyte membrane fuel cell and a direct methanol fuel cell operating at normal temperature or 100□ or less, a phosphoric acid fuel cell operating about 150 to 200□, a molten carbonate fuel cell operating at a high temperature of 600 to 700□, and a solid oxide fuel cell operating at a high temperature of 1000□ or more. These respective fuel cells operate basically by the same principles of electricity generation, but are different with respect to types of fuels, catalysts and electrolytes to be used, etc.

Among others, a direct methanol fuel cell (DMFC) directly uses fuel that is a mixture of high concentration methanol of liquid phase and water instead of hydrogen fuel. The direct methanol fuel cell is lower in output density than that of a fuel cell using hydrogen as direct fuel. However, the direct methanol fuel cell has advantages in that it has a high energy density by volume of methanol used as fuel, easily stores the fuel, and is adapted to operate at a low output and for a long period of time. The direct methanol fuel cell can also be more compactly constituted because additional devices, such as a reformer that reforms fuel to generate hydrogen, etc., is not needed.

The direct methanol fuel cell (DMFC) also includes a membrane electrode assembly (MEA) configured by a polymer electrolyte membrane, and an anode electrode and a cathode electrode contacting both sides of the polymer electrolyte membrane. For the polymer electrolyte membrane, fluoro polymer is used. However, since the methanol is excessively and rapidly permeated into the fluoro polymer membrane, a crossover phenomenon transmitting unreacted methanol to the polymer electrolyte membrane occurs when the direct methanol fuel cell uses high concentration methanol as fuel. Accordingly, in order to lower the concentration of methanol, a fuel that mixes methanol with water must be supplied to the fuel cell system.

### SUMMARY OF THE INVENTION

One aspect of the invention provides a fuel recycling device. The fuel recycling device comprises: a mixing tank; and a condenser connected to the mixing tank. The mixing tank comprises: a fuel receiving port configured to receive fuel from a fuel tank; a cathode inlet configured to receive a cathode effluent of a fuel cell stack; an anode inlet configured to receive an anode effluent of the fuel cell stack; a fuel supplying port configured to supply a mixed fuel to the fuel cell stack, wherein the mixed fuel comprises a recycled fuel and at least part of the fuel from the fuel tank, wherein the recycled fuel is a part of the cathode effluent and the anode effluent; and a gas outlet connected to the condenser and configured to discharge at least part of gas contained in the mixing tank to the condenser; wherein the condenser is configured to condense at least part of the gas discharged from the mixing tank into liquid.

In the fuel recycling device, the mixing tank may further comprise a liquid-gas separating membrane configured to separate a gaseous component contained in the mixing tank. The device may further comprise a pump configured to transfer at least part of the liquid condensed in the condenser to the mixing tank. The fuel recycling device may further comprise a recovering pipe configured to transfer at least part of the liquid condensed in the condenser to the fuel cell stack. The condenser may comprise: a heat exchanger configured to cool the gas discharged from the mixing tank so as to form liquid; and a liquid separator configured to separate at least part of the liquid from the cooled discharged gas. The heat exchanger may comprise a zigzag pipe configured to pass the gas from the mixing tank therethrough so as to cool the gas while passing the zigzag pipe. The liquid separator may comprise a porous material through which cooled discharged gas passes.

Another aspect of the invention provides a fuel cell system comprising: a fuel cell stack for generating electricity; a fuel tank for storing a fuel; a mixing tank coupled with the fuel cell stack and the fuel tank, wherein the mixing tank is configured to generate a mixed fuel by mixing the fuel from the fuel tank and at least part of reaction effluent that is to be received from the fuel cell stack; and a condenser coupled with the mixing tank, wherein the condenser is configured to condense gas discharged from the mixing tank into liquid.

The foregoing fuel cell system may further comprise a feed pump configured to transfer the mixed fuel in the mixing tank to the fuel cell stack. The mixing tank may comprise: a fuel receiving port connected to the fuel tank and configured to receive the fuel from the fuel tank; a cathode inlet configured to receive a cathode effluent of the fuel cell stack; an anode inlet configured to receive an anode effluent of the fuel cell stack; a fuel supplying port configured to supply a mixed fuel to the fuel cell stack, wherein the mixed fuel may comprise at least part of the cathode effluent and at least part of the anode effluent; and a gas outlet connected to the condenser and configured to discharge gas from the mixing tank and transfer the gas to the condenser.

The fuel cell system may further comprise a pump configured to transfer the liquid condensed in the condenser to the mixed tank. The fuel cell system may further comprise a recovering pipe configured to transfer the liquid condensed in the condenser to the feed pump. The fuel cell system may further comprise a valve configured to open and close the recovering pipe. The condenser may comprise: a heat exchanger configured to cool the gas discharged from the mixing tank; and a liquid separator configured to separate liquid formed from cooling by the heat exchanger. The heat exchanger may comprise a zigzag pipe configured to cool the discharged gas, and wherein the zigzag pipe is configured contact air. The liquid separator may comprise a porous material through which the cooled discharged gas passes.

Another aspect of the invention provides a method of recycling fuel in a fuel recycling device. The method comprising: providing the above-described fuel recycling device; receiving the fuel from the fuel tank through the fuel receiving port; receiving the cathode effluent through the cathode inlet; receiving the anode effluent through the anode inlet; supplying the mixed fuel to the fuel cell stack, wherein the mixed fuel may comprise at least part of the fuel from the fuel tank and at least part of the cathode effluent and the anode effluent; discharging gas to the condenser via the gas outlet; and condensing at least part of the discharged gas into liquid in the condenser.

The foregoing method of may further comprise transferring the liquid condensed in the condenser to the mixing tank. The method may further comprise transferring the liquid condensed in the condenser to the fuel cell stack.

Embodiments of the present invention solve the above and other problems. One object of the present invention is to provide a fuel cell system having an excellent recovery efficiency of unreacted fuel and a fuel recycling device for unreacted fuel.

It is another object of the present invention to provide a fuel cell system and a fuel recycling device capable of maintaining the temperature of a mixing tank for recovering unreacted fuel at a proper level.

According to an embodiment of the invention, a fuel recycling device comprises: a mixing tank, the mixing tank comprising: a fuel supplying port configured to supply into the mixing tank a concentrated fuel; a cathode inlet configured to supply into the mixing tank a cathode effluent of an external fuel cell stack; an anode inlet configured to supply into the mixing tank an anode effluent of the fuel cell stack; a stack supplying port configured to supply a mixed fuel comprising the high concentration fuel, the cathode effluent, and the anode effluent to the fuel cell stack; and a gas outlet configured to discharge gas therein; and a condenser coupled with the gas outlet, configured to condense the gas discharged from the mixing tank into a liquid.

According to another embodiment of the invention, a fuel cell system according to the present invention comprises: a fuel cell stack for generating electricity by the chemical reaction of hydrogen and oxygen; a fuel tank for storing a hydrogen containing fuel; a mixing tank coupled with the fuel cell stack and the fuel tank, configured to generate a mixed fuel by mixing the high concentration fuel stored in the fuel tank and reaction effluent of the fuel cell stack; and a condenser coupled with the mixing tank, configured to condense gas discharged from the mixing tank into a liquid.

### BRIEF DESCRIPTION OF THE DRAWINGS

FIG. 1 is a block view showing a direct methanol fuel cell system.

FIG. 2 is a block view showing a direct methanol fuel cell system according to one embodiment of the present invention,

FIGS. 3a and 3b are structural views showing embodiments of condensers that can be used in the fuel cell system of FIG. 2.

FIG. 4 is a structural view showing a condensing water recovering structure that can be used in the fuel cell system of FIG. 2.

### DETAILED DESCRIPTION OF EMBODIMENTS

Hereinafter, embodiments of the present invention will be described in more detail with reference to the accompanying drawings. However, the present invention may be changed in many different forms and should not be construed as limited to the embodiments set forth herein.

For example, although a term referred to as a fuel cell stack is used to describe embodiments of the present invention, it is only for convenience of the use of terminology. The fuel cell stack used in the description of the present invention can include the whole of a stack configured with stacked single cells, a stack configured with flat single cells, and a single stack having only a single cell.

Further, although the embodiment of the present invention mainly describes a direct methanol fuel system, embodiments of the invention may also be applied to a fuel cell system such as, for example, a fuel cell system using acetic acid aqueous solution as fuel, including a mixing tank for recycling unreacted fuel.

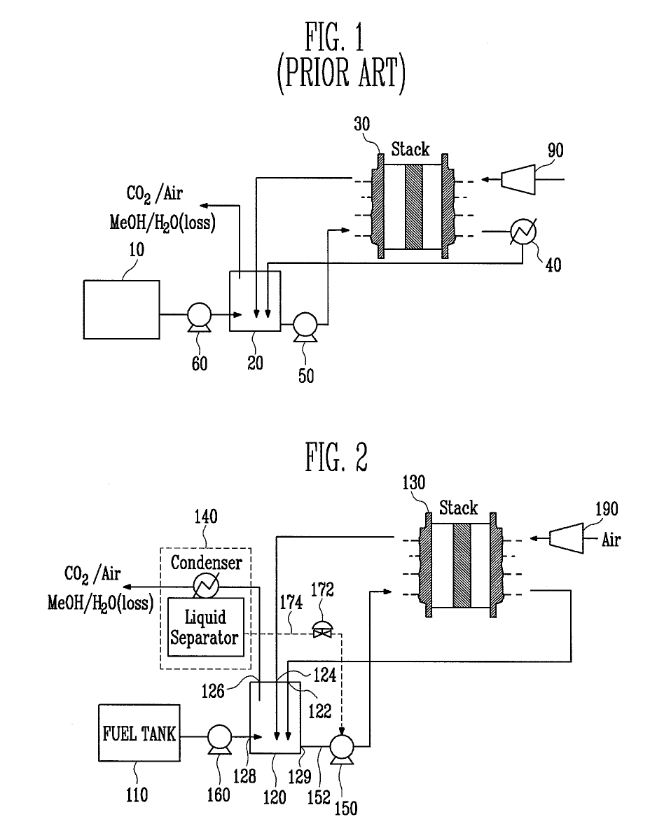

FIG. 1 shows an example of a conventional direct methanol fuel cell. As shown in FIG. 1, the direct methanol fuel cell includes: a fuel cell stack 30 for generating electricity by the chemical reaction of hydrogen and oxygen; a fuel tank 10 for storing high concentration fuel supplied to the fuel cell stack 30; a condenser 40 for recovering unreacted fuel discharged from the fuel cell stack 30; and a mixing tank 20 for supplying hydrogen containing fuel, which is a mixture of unreacted fuel discharged from the condenser 40 and high concentration fuel discharged from the fuel tank 10, to the fuel cell stack 30.

The stack 10 is provided with a plurality of single cells and includes a membrane electrode assembly configured with a polymer electrolyte membrane, and an anode electrode and a cathode electrode contacting both sides of the polymer electrolyte membrane. The anode electrode generates hydrogen ions (H⁺) and electrons (e⁻) by oxidizing methanol contained in the mixed fuel supplied from the mixing tank 20. The cathode electrode converts oxygen in air supplied from the external to oxygen ion and electron. A conductive polymer electrolyte membrane also has a function to prevent the transmission of hydrogen containing fuel, along with a function to exchange hydrogen ions generated from the anode electrode of the polymer membrane into the cathode electrode thereof.

The electric energy generated from the chemical reaction of hydrogen and oxygen in the single cell is converted to conform to an output standard of voltage and current, etc. by a power converting apparatus (not shown) and is then output to external loads. The output of the power converting apparatus may have a structure to charge a secondary battery separately provided.

Further, the direct methanol fuel cell may further include a fuel pump 60 for transferring the high concentration fuel in the fuel tank 10 to the mixing tank 20 and a feed pump 50 for transferring the mixed fuel in the mixing tank 20 to the anode of the fuel cell stack. Also, according to the development aspect of the fuel cell system, it may further include a driving controller (not shown) for controlling the operations of the fuel pump 60, the feed pump 50, and the condenser 40. The driving controller 60 stably maintains the generating efficiency of the fuel cell system by performing operations such as operation constantly maintaining the concentration of fuel mixed with methanol supplied from the mixing tank 20 to the anode electrode of the fuel cell stack 30, etc.

The unreacted fuel, which is mixed with carbon dioxide CO₂ and water and then discharged from the cathode, is moved to the condenser 40. The unreacted fuel condensed in the condenser 40 is collected to the mixing tank 20. Gas components such as carbon dioxide, etc., contained in the unreacted fuel are separated in the mixing tank 20 and then can be discharged. The unreacted fuel collected in the mixing tank 20 and the high concentration fuel supplied from the fuel tank 10 are mixed and then supplied to the anode electrode of the fuel cell stack 30.

In the case of the fuel cell system shown in FIG. 1, the cathode effluent in gas state is first condensed into liquid state through the condenser 40 and then flowed into the mixing tank 20. However, since the effluent just discharged from the cathode has a very high temperature, there is a significant amount of gas that is still not condensed even through the condenser 40. In the cathode effluent mixed with the gas and liquid flowed in the mixing tank 20, the gas components are removed by a gas-liquid separating apparatus in the mixing tank 20 or a natural liquid/gas separating phenomenon in the mixing tank 20 so that the liquid components remain in the mixing tank 20.

As described above, the fuel cell system of FIG. has a problem that although there is a condenser 40 that condenses unreacted gas discharged from the fuel stack before it enters mixing tank 20, it cannot prevent a significant amount of methanol gas not condensed with CO₂ from being lost to the external.

Meanwhile, in order to prevent the loss of the methanol in the gas state, the condensing performance of the condenser 40 can be improved. However, this can increase the manufacturing cost of the condenser 40 as well as considerably decrease the temperature of the condensing liquid from the cathode effluent that flows into the mixing tank 20. As a result, the temperature of the mixed fuel in the mixing tank is lowered, and when the low temperature of the mixed fuel is supplied to the fuel cell stack 30, it is difficult to maintain proper operating temperature of the fuel cell stack 30 so that the operating efficiency is reduced. In this case, in order to raise the operating efficiency of the fuel cell stack 30, heating the mixing tank 30 again is an inefficient option because cooling by the condenser 40 and subsequent reheating of the mixing tank 20 should be performed.

As shown in FIG. 2, a fuel cell system of the present embodiment includes a fuel cell stack 130 generating electricity by the chemical reaction of hydrogen and oxygen; a fuel tank 110 storing a high concentration of hydrogen containing fuel; a mixing tank 130 for generating a mixed fuel by mixing the high concentration fuel stored in the fuel tank 110 with the reactive effluent of the fuel cell stack 130; and a condenser 140 for condensing gas discharged from the mixing tank 120.

The fuel cell system of FIG. 2 further comprises a fuel pump 160 for transferring the high concentration fuel in the fuel tank 110 to the mixing tank 120, a feed pump 150 for transferring the mixed fuel in the mixing tank 120 to the anode of the fuel cell stack, and an air pump 190 for injecting air into a cathode. The fuel cell system may further include a driving controller (not shown) for controlling the operations of the fuel pump 160, the feed pump 150, the condenser 140, and the air pump 190.

The fuel cell system may further include a power converting apparatus (not shown) to convert the electric energy generated from the fuel cell stack to conform to output standards of voltage and current, etc., and then to output it to external loads and a secondary battery (not shown) charged into the output power of the power converting apparatus.

The mixing tank 120 may include a fuel supplying port 128 supplied with high concentration fuel; a cathode inlet 122 supplied with cathode effluent of the external fuel cell stack 130; an anode inlet 124 supplied with anode effluent of the fuel cell stack; a stack supplying port 129 for supplying a mixed fuel of the high concentration fuel, the cathode effluent, and the anode effluent to the fuel cell stack; and a gas outlet 126 for discharging gas separated therein.

The cathode effluent discharged from the cathode of the fuel cell stack 130 of the present embodiment as shown is flowed in the mixing tank 120 as a mixture of gas and liquid in a high temperature state. The liquid components are collected at the bottom of the mixing tank 120 and the gas components are collected at the top so that the separated gas is moved to the condenser 140 of the present embodiment. The gas moved to the condenser 140 includes the gas generated from the cathode effluent as well as the gas generated from the anode effluent. Although the gas of the anode effluent is a relatively small amount, it may be one cause of methanol loss since unreacted methanol can be vaporized by the generation of heat from the fuel cell stack 130. However, the condenser 140 of the present embodiment can condense the gas of the anode effluent, making it possible to minimize the methanol loss.

The mixing tank 120 further includes a gas-liquid separating membrane for preventing leakage of liquid with naturally separated gas. The gas separated in the mixing tank 120 is condensed into liquid by the condensing action of the condenser 140. The liquid condensed in the condenser 140 includes a significant amount of unreacted methanol with water, and the non-condensed gas is mainly carbon dioxide.

Reviewing the temperature of the mixed fuel in the mixing tank 120, the fluid flowed into the mixing tank is the high concentration methanol supplied from the fuel tank 110 and the anode effluent and the cathode effluent of the fuel cell stack 130. Among others, the temperature of the high concentration methanol is low but its amount is small so that it has little effect on the temperature of the mixing tank 120. Therefore, the temperature of the mixing tank 120 is determined by a relatively significant amount of the anode effluent and the cathode effluent of the fuel cell stack 130.

Since the anode effluent and the cathode effluent flowed into the mixing tank 120 is immediately flowed from the fuel cell stack, the temperature in the mixing tank is slightly lower than that in the fuel cell stack. Therefore, the temperature of the mixed fuel in the fuel tank can maintain a high enough temperature as to not degrade the generating efficiency of the fuel cell stack 130 without requiring a separately additional heating means.

Since the fuel cell stack must maintain the temperatures appropriate for chemical reaction, the temperature of the mixed fuel supplied to the stack should be not too low. According to the structure of the present embodiment, the mixed fuel maintaining a sufficient temperature by the effluent from a high temperature of the fuel cell stack 130 is supplied so that the performance of the fuel cell stack 130 can easily be maintained.

The condenser 140 includes a heat exchanger for cooling the gas discharged from the mixing tank 120 to liquefy it, wherein the heat exchanger can be implemented to cool the gas by air injected into a cooling fan or an air compressor. The condenser 140 may further include a means (for example, a gas-liquid separating membrane) for separating condensed liquid and gas such as non-condensed CO₂, etc.

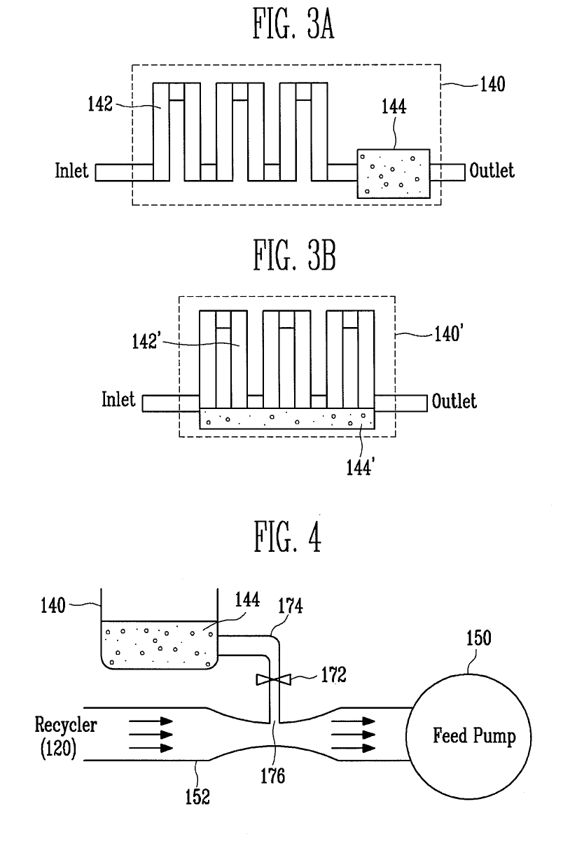

FIGS. 3a and 3b are structural views showing embodiments of condensers usable in the present embodiment. The condensers 140 and 140′ respectively include exchangers 142 and 142′ having a zigzag pipe shape for absorbing the heat of gas discharged from the mixing tank, and liquid separators 144 and 144′ for keeping the liquid condensed in the heat exchangers 142 and 142′ so that it is not discharged into the external.

For the gas discharged from the mixing tank, which passes through the zigzag pipe cooling the discharged gas by air, the components of water and methanol are liquefied to begin condensation to the wall of the pipe. If the pipe has a structure protruded upwardly with respect to the direction of gravity, the significant amount of liquid condensed to the wall of the pipe flows downwardly along the pipe. Therefore, if the pipe for the heat exchangers 142 and 142′ is installed above the mixing tank, the significant amount of condensing water condensed to the wall of the pipe can be returned to the mixing tank by gravity.

The components of water and methanol in the gas state that are not condensed to the wall of the zigzag pipe are condensed in a state of absorption in the liquid separators 144 and 144′ while passing through the inside of the liquid separators 144 and 144′ of porous material.

A method for recycling condensing liquids condensed by a condenser, in particular, for condensing water absorbed in the liquid separator, will now be described.

A method for recycling the condensed water can include flowing the condensed water to the mixing tank to mix it with the mixed fuel or, alternatively, can include flowing the condensed water in a fuel supplying pipe connected to the fuel cell stack from the mixing tank to supply the condensed water with the mixed fuel to the fuel cell stack.

In the former embodiment, the method for flowing in the condensed water into the mixing tank may use a structure including a separate pump or a structure running the condensed water down by gravity. The embodiment including the separate pump increases cost, but it is easy to assure a rotation-free performance and/or high recovery rate. In contrast, while the case using gravity reduces cost, it is difficult to assure a rotation-free performance and/or high recovery rate.

The latter embodiment uses negative pressure generated by the flow of the mixed fuel in the pipe from the mixing tank to the feed pump and by the pumping of the feed pump supplying the mixed fuel from the mixing tank to the fuel cell stack. To this end, the embodiment may include an apparatus that generates negative pressure in order to use the negative pressure in the pipe from the mixing tank to the feed pump, with a valve for controlling the flow of the condensed water in the negative pressure generating apparatus.

In this case, when drawing in significant amounts of condensed water, there is a risk that air also flows into the fuel stack. As a result, although a decrease in methanol loss occurs, the rate at which the condensed water is drawn in through the pipe must be controlled so that it is at a speed slightly lower than the speed at which water is condensed in the condenser.

FIG. 4 shows a structure for drawing in condensed water using Bernoulli's negative pressure applied to the fuel cell system of the present embodiment.

As shown, a part of a pipe 152 between the mixing tank 120 and the feed pump is constituted in a venture tube form having a thin middle section. In the venture tube, a portion in which the largest negative pressure is generated is provided with an orifice 176 connected to a recovering pipe 174. The condensing water collected in the liquid separator 144 of the condenser 140 can be moved to the orifice 176 through the recovering pipe 174.

The condensed water flows in the feed pump 150 from the orifice 176 by the negative pressure generated when the mixed fuel of the mixing tank 120 passes through the venture tube according to the operation of the feed pump 150. As a result, the condensed water collected in the liquid separator 144 along the recovering pipe 150 connected to the orifice 176 can be supplied to the fuel cell stack.

The control valve 172 shown in FIG. 4 prevents air from being flowed in through the orifice 176 when the concentration of the fuel supplied to the fuel cell stack is made too low concentration by too much condensed water, or the condensed water collected in the liquid separator 144 is lacking.

The control valve 172 can be controlled by the driving controller (not shown). In order to prevent the low concentration of the fuel, the maximum time to open the control valve 172 is limited and the minimum time to close the control valve 172 is also limited so that the mixed degree of the condensed water and the fuel per the unit time can be controlled. Also, in order to prevent air from being flowed in through the orifice 176, the opening time of the control valve 172 can be controlled per a predetermined unit time so that the amount of the condensed water drawn in by the negative pressure of the orifice is less than the minimum amount of the condensed water accumulated in the liquid separator 144.

By practicing the fuel cell system of the present invention according to the embodiments as described above, the recovering efficiency of the unreacted fuel in the fuel cell system using aqueous solution such as DMFC is improved.

In addition, embodiments of the present invention improve the operating efficiency of the fuel cell stack with the recovering efficiency of the unreacted fuel.

Although a few embodiments of the present invention have been shown and described, it would be appreciated by those skilled in the art that changes might be made in this embodiment without departing from the principles and spirit of the invention, the scope of which is defined in the claims and their equivalents.

What is claimed is:

1. A fuel recycling device comprising:
a mixing tank; and
a condenser connected to the mixing tank;
wherein the mixing tank comprises:
a fuel receiving port configured to receive fuel from a fuel tank;
a cathode inlet configured to receive a cathode effluent of a fuel cell stack;
an anode inlet configured to receive an anode effluent of the fuel cell stack;
a fuel supplying port configured to supply a mixed fuel to the fuel cell stack, wherein the mixed fuel comprises a recycled fuel and at least part of the fuel from the fuel tank, wherein the recycled fuel is a part of the cathode effluent and the anode effluent; and
a gas outlet connected to the condenser and configured to discharge at least part of gas contained in the mixing tank to the condenser;
wherein the condenser is configured to condense at least part of the gas discharged from the mixing tank into liquid.

2. The fuel recycling device of claim 1, wherein the mixing tank further comprises a liquid-gas separating membrane configured to separate a gaseous component contained in the mixing tank.

3. The fuel recycling device of claim 1, further comprising a pump configured to transfer at least part of the liquid condensed in the condenser to the mixing tank.

4. The fuel recycling device of claim 1, further comprising a recovering pipe configured to transfer at least part of the liquid condensed in the condenser to the fuel cell stack.

5. The fuel recycling device of claim 1, wherein the condenser comprises:
a heat exchanger configured to cool the gas discharged from the mixing tank so as to form liquid; and
a liquid separator configured to separate at least part of the liquid from the cooled discharged gas.

6. The fuel recycling device of claim 5, wherein the heat exchanger comprises a zigzag pipe configured to pass the gas from the mixing tank therethrough so as to cool the gas while passing the zigzag pipe.

7. The fuel recycling device of claim 5, wherein the liquid separator comprises a porous material through which cooled discharged gas passes.

8. A fuel cell system comprising:
a fuel cell stack for generating electricity;
a fuel tank for storing a fuel;
a mixing tank coupled with the fuel cell stack and the fuel tank, wherein the mixing tank is configured to generate a mixed fuel by mixing the fuel from the fuel tank and at least part of reaction effluent that is to be received from the fuel cell stack; and
a condenser coupled with the mixing tank, wherein the condenser is configured to condense gas discharged from the mixing tank into liquid.

9. The fuel cell system of claim 8, further comprising a feed pump configured to transfer the mixed fuel in the mixing tank to the fuel cell stack.

10. The fuel cell system of claim 8, wherein the mixing tank comprises:
a fuel receiving port connected to the fuel tank and configured to receive the fuel from the fuel tank;
a cathode inlet configured to receive a cathode effluent of the fuel cell stack;
an anode inlet configured to receive an anode effluent of the fuel cell stack;
a fuel supplying port configured to supply a mixed fuel to the fuel cell stack, wherein the mixed fuel comprises at least part of the cathode effluent and at least part of the anode effluent; and
a gas outlet connected to the condenser and configured to discharge gas from the mixing tank and transfer the gas to the condenser.

11. The fuel cell system of claim 8, further comprising a pump configured to transfer the liquid condensed in the condenser to the mixed tank.

12. The fuel cell system of claim 9, further comprising a recovering pipe configured to transfer the liquid condensed in the condenser to the feed pump.

13. The fuel cell system of claim 12, further comprising a valve configured to open and close the recovering pipe.

14. The fuel cell system of claim 8, wherein the condenser comprises:
a heat exchanger configured to cool the gas discharged from the mixing tank; and
a liquid separator configured to separate liquid formed from cooling by the heat exchanger.

15. The fuel cell system of claim 8, wherein the heat exchanger comprises a zigzag pipe configured to cool the discharged gas, and wherein the zigzag pipe is configured contact air.

16. The fuel cell system of claim 14, wherein the liquid separator comprises a porous material through which the cooled discharged gas passes.
